(19) United States
(12) Patent Application Publication
(10) Pub. No.: US 2009/0136361 A1
(43) Pub. Date: May 28, 2009

(54) Vacuum turbomolecular pump

(76) Inventors: Alois Greven, Erkelenz (DE); Christian Harig, Koln (DE)

Correspondence Address: Fay Sharpe LLP, 1228 Euclid Avenue, 5th Floor, The Halle Building, Cleveland, OH, 44115, US

(21) Appl. No.: 11/991,346

(22) PCT Filed: Aug. 17, 2006
(86) PCT No.: PCT/EP2006/065384

§ 371 Date: Feb. 29, 2008

(30) Foreign Application Priority Data
Sep. 1, 2005 (DE) 10 2005 041 501.6

(51) Int. Cl. F04D 27/02; H02P 6/14; F04D 19/04

(52) U.S. Cl. 417/45; 318/400.3; 417/423.4

(57) ABSTRACT

A vacuum turbomolecular pump (10) is driven by a brushless direct-current drive motor (16) comprising stator coils and a permanent-magnetically excited motor rotor. When rotating, the motor rotor produces an electromotive force oriented counter to the direction of rotation. A motor controller (22) is connected to the stator coils and which generates a current from the supply voltage, this current being induced in the stator coils. In addition, a rotational frequency regulator (32) limits the rotational frequency (f) of the drive motor (16) to a nominal rotational frequency (f_{N}). A power supply (20) is connected to the motor controller (22) and supplies a constant direct current voltage as a supply voltage (U_{V}) for the motor controller (22). The power supply (20) is designed so that the constant supply voltage (U_{V}) is low enough that, at a limit rotational frequency (f_{G}), the electromotive force is equal to the drive force that can be maximally generated by the motor controller (22) and by the stator coils. The limit rotational frequency (f_{G}) is less than 1.3 times the nominal rotational frequency (f_{N}). As a result, the motor output is limited and the rotational frequency of the drive motor (16) is physically restricted to a limit rotational frequency (f_{G}) in a reliable manner.

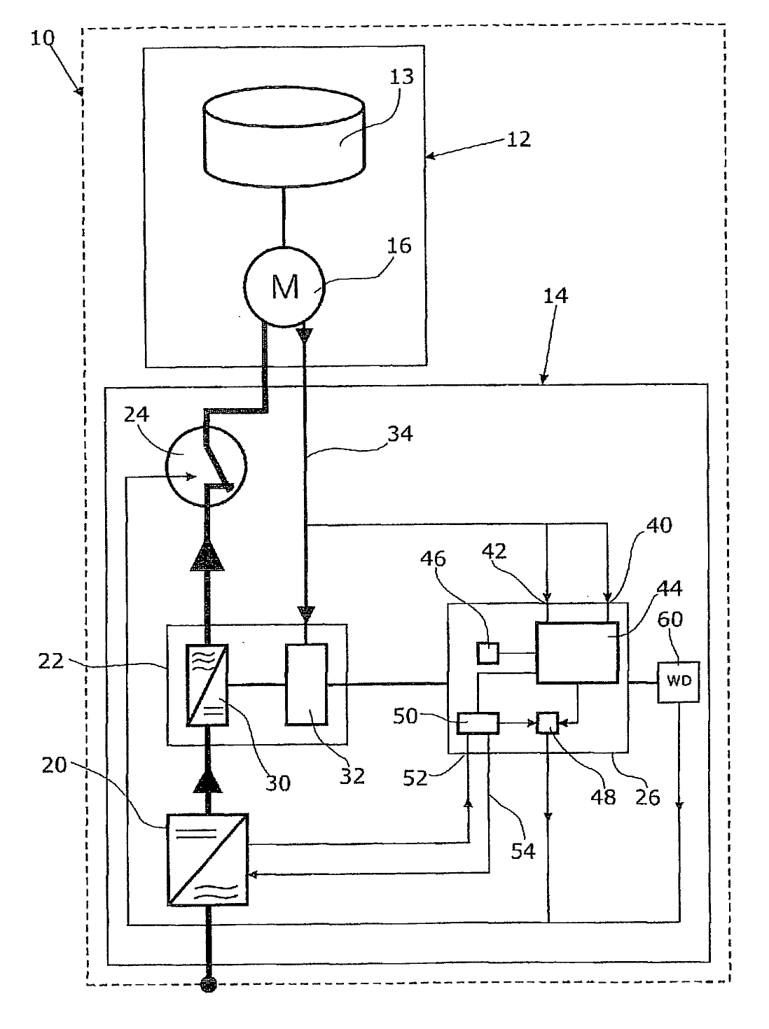

### BACKGROUND

The invention relates to a vacuum turbomolecular pump comprising a direct-current drive motor which includes a permanent magnetically excited motor rotor and stator coils.

Vacuum turbomolecular pumps are fast-rotating turbo machines designed for rotational speeds in the range of 20,000 to 100,000 rotations per minute and respectively for maximum rotational frequencies of 300 Hz to 1,700 Hz. The drive means for the pump rotor are often provided as brushless direct-current drive motors comprising a permanent magnetically excited motor rotor, because of their favorable power loss balance.

In case of high rotational frequencies, rotor components which during operation happen to detach themselves from the rotor, have developed a very high kinetic energy. In case of a crash, vacuum turbomolecular pumps, inherently rotating at very high rotational frequencies, will cause a considerable risk of personal injury. This risk may be reduced only by a corresponding protective armoring of the pump stator, which involves considerable expenditure. Particularly in large-sized turbo machines, it is not possible to provide the pump housing with a sufficient degree of intrinsic safety. A rare but eminently dangerous cause for accidents of the above kind resides in an increase of the rotational speed of the rotor beyond the nominal speed; this is because the strength of the attachment of the rotor vanes to the rotor hub is designed merely for the nominal speed plus a relative low safety margin. Therefore, reliable prevention of excessive rotational speeds or excessive rotational frequencies, i.e. rotational frequencies above the nominal rotational frequency, is highly imperative.

Possible failure of the rotational-frequency regulator in the motor controller will result in a considerable risk of the rotational frequency rising above the nominal rotational frequency.

Thus, customary safety requirements demand the provision of a second, independent rotational-frequency control device which, along with additional sensors, an additional time basis etc., will result in considerable added expenditure.

### SUMMARY

In view of the above, it is an object of the invention to provide a vacuum turbomolecular pump wherein protection from excessive rotational speeds is obtained at low expenditure while effecting a high safety level.

The vacuum turbomolecular pump in one aspect comprises a voltage supply unit for supplying to the motor controller a supply voltage U_{V} which is constant and is set to such a low level that, at a limit rotational frequency f_{G}, the electromotive force will be equal to the drive force that can be maximally generated by the motor controller and by the stator coils, said limit rotational frequency f_{G} being less than 1.3 times the nominal rotational frequency f_{N}.

In brushless direct current motors with permanently excited rotor, a maximum rotational frequency is established automatically since the maximum rotational frequency is reached when the voltage and respectively electromotive force (EMF) induced in the stator coils by the permanent magnet of the rotor becomes so large that the maximally available drive force will be completely compensated for. The voltage induced in the stator coils by the motor rotor is proportionate to the rotational number and the rotational frequency, respectively. Since the motor controller receives electric energy from a voltage supply unit and the voltage supply unit delivers a constant direct voltage as a supply voltage for the motor controller, the rotational frequency cannot rise above the maximum rotational frequency.

The electric energy made available to the motor controller by the voltage supply unit is exactly at a level to the effect that, at the relatively low limit rotational frequency f_{G} orienting itself by the nominal rotational frequency f_{N}, a balance is obtained between the electromotive force and the drive force which can be maximally generated in the stator coils by the motor controller as dictated by the power limit. Even if the actual rotational-frequency regulator as such should fail, the drive motor for physical reasons cannot be accelerated by more than 1.3 times above the nominal rotational frequency f_{N}. The limit rotational frequency f_{G} is preferably smaller than 1.1 times the nominal rotational frequency f_{N}.

In practice, the pump rotor of a fast-rotating vacuum turbomolecular pump is designed to withstand increases of the rotational frequency by 10-30% relative to the nominal rotational frequency without being destroyed and without the rotor vanes being stretched to the point of colliding with the pump stator. By limiting the electric energy available to the motor controller, the drive motor and thus the pump rotor are reliably protected from too high excessive rotational speeds. This obviates the need for a second rotational-speed control system.

According to a preferred embodiment, the protective device comprises:
an EMF input conducting the voltage induced in the stator coils by the rotor magnet,
an EMF limit value store where EMF limit values are stored in dependence on the frequency,
an EMF evaluation module configured to detect whether the voltage value measured at the EMF input falls short of the EMF limit value, and
a signaling device configured to emit a shortfall signal when the EMF evaluation module detects a shortfall.

The voltage generated in the stator coils by the electromotive force is dependent, apart from the rotational speed, also on the magnetic force of the permanent magnet(s) of the motor rotor. The magnetic force of permanent magnets, however, will be deteriorate with advancing operating life and also due to temperature influences. Thus, over time, the electromotive force counteracting the drive force generated by the motor controller via the stator coils will, as measured for the same rotational frequency, become lower so that the balance will be not be reached anymore at the fixed limit rotational frequency f_{G} but at a rotational frequency thereabove.

This disadvantage is avoided in that the voltage induced in the stator coils by the motor rotor is monitored with respect to the rotational frequency. A reduction of the inherent magnetism of the motor rotor will cause a reduction of the induced voltage as well. This occurrence is detected, in the given case, with the aid of the above-mentioned features, and there is emitted a corresponding signal which can be used for correction and/or for switching off the drive motor.

According to a preferred embodiment, the protective device comprises a supply voltage input and is operative to emit an overvoltage signal when the supply voltage measured at the input exceeds a prestored supply-voltage limit value. In this manner, the protective device will monitor the voltage supply unit which is responsible for the passive limitation of the rotational frequency of the drive motor. Upon detection of an increase of the supply voltage delivered by the voltage supply unit, a corresponding overvoltage signal is emitted, thus avoiding that a simultaneous fallout of the rotational-frequency regulator will cause the rotational frequency of the drive motor to increase above the limit rotational frequency.

According to a preferred embodiment, the signaling device is connected to a switch-off element provided to switch off the drive motor when receiving a shortfall signal or an overvoltage signal. Should a malfunction occur, no effort is made to first correct the same by a corresponding control procedure; instead, the drive motor will be immediately switched off by the switch-off element so as to exclude any risk which might possibly result from further continuance of operation.

Preferably, the signaling device is connected to the voltage supply unit so that, upon receipt of a shortfall or overvoltage signal, the voltage supply unit will reduce the supply voltage correspondingly. This makes it possible, particularly, to compensate for the effect resulting from a weakening of the rotor magnet. Since, in those situations where the rotor magnet is weakening while the supply voltage remains constant, the highest rotational frequency obtainable under the physical aspect is caused to increase, this physically obtainable rotational frequency can be reduced again to the limit rotational frequency f_{G} by effecting a corresponding reduction of the supply voltage.

According to a method ranking as a further independent aspect and related to protecting a vacuum turbomolecular pump from excessive rotational speeds, the following method steps are provided:
measuring the voltage induced in the stator coils by the rotor magnet,
comparing the measured voltage with a stored EMF limit value, and
emitting a shortfall signal when the measured voltage falls short of the EMF limit value.

Using this method, the magnetic force of the motor-rotor permanent magnet is continuously monitored. If the magnetic force of the permanent magnet becomes weaker over time, which simultaneously causes an increase of the highest rotational frequency obtainable under the physical aspect, a corresponding shortfall signal will be output so that appropriate measures can be taken.

By way of alternative or in addition to the above, an overvoltage signal can be emitted when the supply voltage U_{V} exceeds a stored supply-voltage limit value. Thereby, it is safeguarded that an increase of said physically obtainable rotational frequency cannot go unnoticed.

Preferably, the drive motor will be switched off when an overvoltage signal or a shortfall signal is emitted. In this manner, it is precluded with high reliability that the limit rotational frequency f_{G} is exceeded.

By way of alternative or as a supplementary measure, the supply voltage can be correspondingly reduced upon receipt of an overvoltage signal and/or upon receipt of a shortfall signal. Thereby, said physically obtainable rotational frequency can be reduced again to the limit rotational frequency f_{G} in the given case.

The following is a detailed description of an embodiment of the invention with reference to the drawings.

### BRIEF DESCRIPTION OF THE DRAWINGS

The FIGURE is a schematic view of a vacuum turbomolecular pump.

### DETAILED DESCRIPTION

Shown in the FIGURE is a fast-rotating vacuum turbomolecular pump 10 substantially comprising a pump unit 12 and a control unit 14. The turbomolecular pump serves for generating a high vacuum. Vacuum turbomolecular pumps of this type are running at nominal rotational frequencies f_{N} of 300-1,000 Hz. Pump unit 12 comprises a pump rotor 13 and a drive motor 16. Control unit 14 comprises, as its essential elements, a voltage supply unit 20, a motor controller 22, a switch-off module 24 as well as a protective device 26. Control unit 14 serves for controlling and monitoring the drive motor 16.

As a consequence of the high nominal rotational frequency of vacuum turbomolecular pumps, the nominal rotational frequency f_{N} for which the strength of the pump rotor has been specified, must not be significantly exceeded. Otherwise, the centrifugal forces would increase to such extent that the pump rotor 13 and in particular the rotor vanes could be destroyed by these forces and would in effect act as dangerous projectiles. Since it is not possible to construct the housing of pump unit 12 with any desired degree of stability and inherent safety, it is required to provide reliable and redundant monitoring and safety devices so as to prevent that the nominal rotational frequency f_{N} is exceeded by a noteworthy extent.

For reasons of a favorable power loss balance, drive motor 16 is an electronically commuted brushless direct current motor. Thus, drive motor 16 comprises stator coils on the stator side while the motor rotor is of a permanent-magnetic type by inclusion of at least one permanent magnet. Disadvantageously, however, in case of malfunction or failure of the rotational speed control, it may happen that this type of drive motor due to its constructional principles is accelerated far beyond the nominal rotational frequency f_{N}, provided that the voltage supply unit delivers enough energy for such an effect to occur.

Motor controller 22 comprises a converter 30 and a rotational-frequency regulator 32 which receives the actual frequency F_{I} via a signal line 34 from drive motor 16, compares said frequency to a desired rotational frequency fₛ and returns to converter 30 a control signal corresponding to the resultant difference. From the rectified electric energy delivered by voltage supply unit 20, converter 30 generates corresponding currents for the stator coils of drive motor 16. During disturbance-free normal operation, drive motor 16 will be run up to the nominal rotational frequency f_{N} solely by motor controller 22 and be operated at the constant nominal rotational frequency f_{N}.

A special feature of a direct current drive motor with stator coils and permanently excited motor rotor is the inducing of electric voltages into the stator coils by means of the rotating motor rotor of the permanently excited type. The resultant force, counteracting the drive force of drive motor 16, is called the electromotive force. A rotational moment for accelerating the motor rotor can be generated only if the original voltage made available by voltage supply unit 20 and kept ready for use by motor controller 22 for power supply to the stator coils, is larger than the opposite voltage generated by the motor rotor, i.e. if the drive force is higher than the counteracting electromotive force.

Voltage supply unit 20 is operative to deliver a constant supply voltage U_{V}. Supply voltage U_{V} is set to such a low level that, at a limit rotational frequency f_{G}, the maximum drive force to be generated by motor controller 22 and respectively converter 30 and by the stator coils of drive motor 16, will be identical to the electromotive force. The limit rotational frequency f_{G} is selected to be slightly larger than the nominal rotational frequency f_{N}. The limit rotational frequency f_{G} should be smaller than 1.3 times the nominal rotational frequency f_{N} and preferably is 1.05 times the nominal rotational frequency f_{N}.

Even in case of failure of the rotational speed regulator and the thus caused maximum power supply to the stator coils, it is still precluded that the drive motor 16 could accelerate the pump rotor 13 beyond the limit rotational frequency f_{G} since, at the limit rotational frequency f_{G} or higher rotational frequencies, the electromotive force will be identical to or higher than the drive force that the stator coils are able to generate from the available electric energy. This well-aimed limitation of the supply voltage available from voltage supply unit 20 will introduce, as it were, a power limitation by which the maximum possible rotational frequency f is physically limited.

The voltage which during rotation is generated in the stator coils by the permanently excited motor rotor and, respectively, the thus obtained electromotive force is directly proportionate to the magnetic force of the rotor magnet(s) in the motor rotor. Over time, and due to damaging influences caused by high temperatures, the magnetic force of permanent magnets will tend to fade. As a result, also the voltage induced in the stator coils by the permanent magnet(s) of the motor rotor and the thereby generated electromotive force will decrease over time, always with reference to the same rotational frequency. Consequently, the rotational frequency at which the electromotive force and the electric energy delivered by motor controller 22 for feeding the stator coils are in mutual balance, will increase over time. This entails a new danger and thus is undesired.

For this reason, control unit 14 comprises a protective device 26 monitoring the demagnetization process in the permanent-magnetic motor rotor. Protective device 26 is provided with an EMF input 40 and a rotational-frequency input 42. Both inputs 40,42 are connected to an EMF evaluation module 44 which also has an EMF limit value store 46 and a signaling device 48 associated thereto. Applied to EMF input 40 is the voltage induced in the stator coils by the permanently excited motor rotor. At the rotational-frequency input 42, the same signal will be evaluated with regard to the rotational frequency f of drive motor 16. In said EMF evaluation module 44, both signals are compared, in dependence on the rotational frequency, to the EMF limit values stored in said EMF limit value store 46. In the case that the voltage which is applied to EMF input 40 at a certain rotational frequency f is lower than the voltage value stored in EMF limit value store for the same rotational frequency, protective device 26 will output a shortfall signal via the signaling device 48, which shortfall signal will in turn cause the switch-off module 24 to open a switch so that the stator coils will not be connected to the motor controller 22 anymore and the drive motor 16 will thus be switched off.

Protective device 26 comprises a further control element, notably a voltage monitoring module 50. In said voltage monitoring module 50, the supply voltage U_{V} kept available by the voltage supply unit 20 at its output is monitored and, if required, is decreased via a supply voltage control line 54. The monitoring module 50 will intervene if voltage supply unit 20 delivers a supply voltage higher than stored in said monitoring module 50. Should the correction of the supply voltage U_{V} via control line 54 be unsuccessful, protective device 26 will via signaling device 48 emit an overvoltage signal which in turn will cause the switch-off action of switch-off module 24. Thus, the output signal of the signaling device 48 can be a supply-voltage overvoltage signal from monitoring module 50 or, alternatively, an EMF shortfall signal from EMF evaluation module 44.

For monitoring the hardware of protective device 26 and the basic functions of the latter, use is made of a watchdog module 60 which has it own time basis and in case of malfunction will output a switch-off signal to the switch-off module 24 which in turn will then switch off the drive motor 16.

The invention has been described with reference to the preferred embodiments. Modifications and alterations may occur to others upon reading and understanding the preceding detailed description. It is intended that the invention be construed as including all such modifications and alterations insofar as they come within the scope of the appended claims or the equivalents thereof.

1. A vacuum turbomolecular pump comprising
a brushless direct-current drive motor comprising stator coils and a permanent-magnetically excited motor rotor, said motor rotor producing an electromotive force oriented opposite to the direction of rotation,
a motor controller connected to the stator coils and operative to generate a current from a supply voltage, said current being impressed into the stator coils,
a rotational-frequency regulator limiting the rotational frequency of the drive motor to a nominal rotational frequency, and
a voltage supply unit connected to the motor controller and operative to supply a constant direct voltage as a supply voltage for the motor controller, said voltage supply unit is configured to cause the constant supply voltage to be selected at such a low level such that, at a limit rotational frequency, the electromotive force is equal to the maximum drive force which the motor controller and the stator coils can generate, said limit rotational frequency being smaller than 1.3 times the nominal rotational frequency.

2. The vacuum turbomolecular pump according to claim 1, further including a protective device comprising:
an EMF input which receives a voltage induced in the stator coils by the rotor magnet,
an EMF limit value store which stores EMF limit values in dependence on the rotational frequency,
an EMF evaluation module configured to detect whether the voltage measured at the EMF input falls short of the EMF limit value at a corresponding rotational frequency, and
a signaling device configured to emit a shortfall signal when the EMF evaluation module detects a shortfall.

3. The vacuum turbomolecular pump according to claim 1, wherein the limit rotational frequency is smaller than 1.1 times the nominal rotational frequency.

4. The vacuum turbomolecular pump according to claim 2, wherein the protective device comprises a supply voltage input and that the signaling device outputs an overvoltage signal when a stored supply-voltage limit value is exceeded.

5. The vacuum turbomolecular pump according to claim 4, wherein the signaling device is connected to a switch-off module operative to switch off the drive motor upon receipt of the shortfall signal or the overvoltage signal.

6. The vacuum turbomolecular pump according to claim 4, wherein the protective device is connected to the voltage supply unit and that the protective device causes the voltage supply unit to reduce the supply voltage upon receipt of the shortfall signal or the overvoltage signal.

7. A method for protecting a vacuum turbomolecular pump from an excessive rotational speed, said vacuum turbomolecular pump comprising:
a brushless direct-current drive motor comprising stator coils and a permanent-magnetically excited motor rotor, said motor rotor producing an electromotive force oriented opposite to the direction of rotation,
a motor controller connected to the stator coils and operative to generate a current from a supply voltage, said current being impressed into the stator coils,
a rotational-frequency regulator limiting the rotational frequency of the drive motor to a nominal rotational frequency, and
a voltage supply unit connected to the motor controller and operative to supply a constant direct voltage as a supply voltage for the motor controller, said voltage supply unit being configured to cause the constant supply voltage to be at a level such that, at a limit rotational frequency, the electromotive force is equal to the maximum drive force which the motor controller and the stator coils can generate, said limit rotational frequency being smaller than 1.3 times the nominal rotational frequency,
said method comprising the steps of:
measuring the voltage induced in the stator coils by the motor rotor,
comparing the measured voltage with a stored EMF limit value,
emitting a shortfall signal when the measured voltage falls short of the EMF limit value.

8. The method for protecting a vacuum turbomolecular pump according to claim 7, further including the method step of:
outputting an overvoltage signal in response to the supply voltage exceeding a stored supply-voltage limit value.

9. The method for protecting a vacuum turbomolecular pump according to claim 7, further including the method step of:
switching off the drive motor when an overvoltage signal or a shortfall signal is output.

10. The method for protecting a vacuum turbomolecular pump according to claim 8, further including the method step of:
reducing the supply voltage upon receipt of an overvoltage signal.

11. A method of protecting the vacuum turbomolecular pump according to claim 1, the method comprising:
measuring the voltage induced in the stator coils by the motor rotor,
comparing the measured voltage with a stored EMF limit value,
emitting a shortfall signal when the measured voltage falls short of the EMF limit value.

12. A method of protecting a vacuum turbomolecular pump, the method comprising:
measuring a stator coil voltage induced in stator coils of a rotor drive motor;
comparing the measured stator coil voltage with a limit value;
emitting a shortfall signal in response to the measured stator coil voltage falling short of the limit value.
